(19) United States
(12) Patent Application Publication
(10) Pub. No.: US 2015/0006382 A1
(43) Pub. Date: Jan. 1, 2015

(54) SYSTEMS AND METHODS FOR IMPLEMENTING MONEY ORDERS

(71) Applicant: German Scipioni, San Jose, CA (US)

(72) Inventor: German Scipioni, San Jose, CA (US)

(21) Appl. No.: 13/929,655

(22) Filed: Jun. 27, 2013

(51) Int. Cl. G06Q 20/04; G06Q 20/10

(52) U.S. Cl. CPC G06Q 20/042; G06Q 20/10
USPC 705/44

(57) ABSTRACT

A user may use an online payment account of a payment service provider to convert an electronic payment into a code, e.g., a barcode, an image, a Quick Response (QR) code, or the like. The code may include information indicating a routing number, a payee, and an amount of payment. The user may bring the code to a participating merchant, who is registered with the payment service provider. The participating merchant may verify the code and may print a payment instrument, e.g., a money order, a cashier's check, or the like, for the user.

### BACKGROUND

1. Field of the Invention

The present invention generally relates to systems and methods for converting electronic payments into payment instruments.

2. Related Art

Payment service providers, such as PayPal, Inc. of San. Jose, Calif., provide various services for sending and receiving electronic payments. For example, a consumer may set up a payment account with a payment service provider. The consumer then may purchase goods or services from online merchants by making payments using the payment account through the payment service provider.

Nevertheless, many payment transactions today are still carried out through cash or physical payment instruments. For example, some government entities accept only cash, personal check, or money orders for certain official fees. Further, small businesses or individual payees may not have the ability to receive electronic payments and may prefer cashier's check or money orders. Payment service providers may not be a bank and may not be able to issue a physical payment instrument, such as a personal check, from a user's payment account. Thus, it may be difficult for the user to tender payments to individuals or merchants that do not accept electronic payments.

Therefore, there is a need for a system or method, which allows a user of a payment service provider to convert an electronic payment into a physical payment instruments, such as a money order, a personal check, or a cashier's check.

### BRIEF DESCRIPTION OF THE FIGURES

FIG. 1 is block diagram of a networked system suitable for implementing a process for converting electronic payments into physical payment instruments according to an embodiment.

FIG. 2 is a flowchart showing a process for converting electronic payments into physical payment instruments according to one embodiment.

FIG. 3 is a flowchart showing a process for printing a physical payment instrument at a merchant according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a user may set up a payment account at a service provider. The user may use the payment account to convert an electronic payment into a code, e.g., a barcode, an image, a Quick Response (QR) code, or the like. The code may include information indicating a routing number, a payee, and an amount of payment. The user may bring the code to a participating merchant, who is registered with the service provider. The merchant may verify the code and may print a physical payment instrument, e.g., a money order, a cashier's check, or the like, for the user. In one embodiment, the user may forward the code to the payee and the payee may bring the code to a participating merchant to print a physical payment instrument based on the code.

In another embodiment, the physical payment instrument, which is printed from the code, may not be activated or cashable by the payee until the user of the payment account activates the code. In one embodiment, the physical payment instrument may be printed with advertisements for goods or services provided at the merchant. Thus, the merchant may encourage additional purchases at the merchant's store when the user or the payee visits the merchant to print the physical payment instrument.

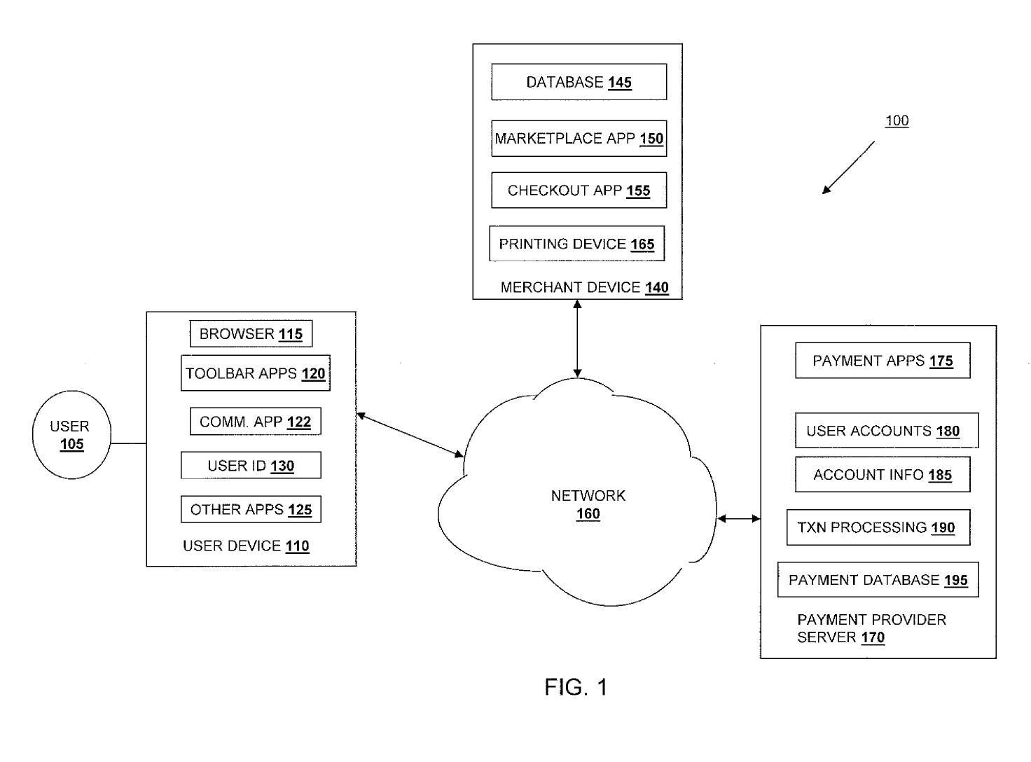

FIG. 1 is a block diagram of a networked system 100 configured to facilitate a process for converting an electronic payment into a physical payment instrument in accordance with an embodiment of the invention. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 360. Payment provider server 170 may be maintained by a payment service provider, such as PayPal, Inc. of San Jose, Calif.. A user 105, such as a sender or consumer, utilizes user device 110 to perform a transaction using payment provider server 170. A user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing gifts from multiple merchants.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a gift list and/or merchant sites for viewing and purchasing gifts. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a recommended gift may be a donation to charity in the name of the recipient. Merchant server 140 includes a database 145 identifying available products and/or services (e.g., collectively referred to as items) which may be made available for viewing and purchase by user 105. Accordingly, merchant server 140 also includes a marketplace application 150 which may be configured to serve information over network 360 to browser 115 of user device 110. In one embodiment, user 105 may interact with marketplace application 150 through browser applications over network 160 in order to view various products, food items, or services identified in database 145.

Merchant server 140 also includes a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID).

Checkout application 155 may be configured to receive payment via a plurality of payment methods including cash, credit cards, debit cards, checks, money orders, or the like. The merchant server 140 may also include a printing device 165 for making printouts in sheets of paper. In one embodiment, printing device 165 may be connected to merchant server 140 via a wire line or wireless. Printing device 165 may receive printing information from merchant server 140 and may print the printing information on sheets of paper. For example, merchant server 140 may forward printing information for printing a money order to printing device 165. Printing device 165 then may print out a money order based on the printing information.

Payment provider server 170 may be maintained, for example, by an online payment service provider which may provide payment between user 105 and the operator of merchant server 140. In this regard, payment provider server 170 includes one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, user names, phone numbers, credit card information, bank information, or other financial information which may be used to facilitate online transactions by user 105. Account information may also include user purchase history and user ratings. Profiles for primary and secondary users may also be included in account information. Offers and/or incentives from creditors may also be stored with account information 185, as well as bids submitted by a creditor for the payment provider offering a product of the creditor. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary, such as the set up and management payments by the user after the initial purchase (e.g., pay after purchase) as discussed herein.

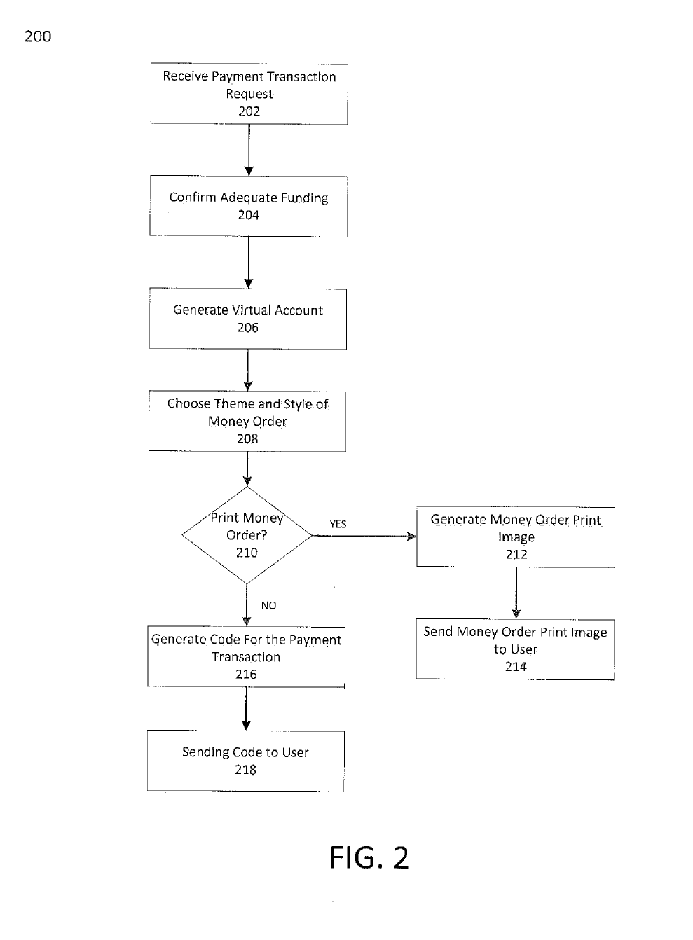

FIG. 2 is a flowchart showing a process 200 for converting electronic payments into physical payment instruments. Initially, a user may set up a payment account at a service or payment provider, such as PayPal, Inc., of San Jose. The payment account may be associated with a bank account or credit account for funding the payment account. The user may wish to generate a physical payment instrument, such as a money order, a cashier's check, a personal check or the like, by using funds from the payment account with the service provider. The user may operate user device 110, such as a mobile device or a computer, to request a physical payment instrument from the payment service provider. For example, the user may visit the service provider's website using browser 115 or may execute an application that access the service provider's service.

As step 202, the service provider may receive the request for a physical payment instrument via payment provider server 170. Payment provider server 170 may prompt the user to enter authentication credentials, such as user ID 130 and password. Payment provider server 170 may verify the user's authentication credential by matching user ID 130 and password with account information 185. If the user's authentication credential is verified, the payment provider server 170 may forward account information of the user to user device 110. The account information may include user's identification profile, funds currently available, and other account settings. The account information may be displayed to the user at user device 110.

Functions, such as “make a payment,” “receive a payment,” or the like may also be available to the user at user device 110. The user may choose the function for making a payment. Various options for making a payment may be presented to the user. For example, payments may be made via email, text message, money order, check, and the like. Further, various options for funding the payment may be presented to the user. For example, the payment may be funded by a balance of the payment account, by a bank account linked to the payment account, or by a line of credit, such as Bill Me Later.

The user may choose to make the payment via a money order using funds from a bank account. Payment provider server 170 may then request that the user enter the identification of the payee and the payment amount using user device 110. The identification of the payee may include name and address of the payee. The payment amount may be made in various currencies, such US dollar, Japanese Yuen or the like. Thus, the user may choose one of the currencies and may set the amount for that currency for making a payment.

User device 110 may forward the information entered by the user to payment provider server 170 via network 160. Payment provider server 170 may receive the information and may verify that adequate fund is available in the user's payment account for making the payment at step 204. Payment provider server 170 may automatically calculate and convert the fund into the currency chosen by the user to generate the money order. In particular, the payment provider server 170 may retrieve currency conversion rates in real time from a public trading system to calculate the current conversion amount for the user's designated currency.

If payment provider server determines that adequate funding is available for making the payment, payment provider server 170 may generate a virtual account for the payment at step 206. The virtual account may include a routing number, e.g., a bank number and an account number. For example, the routing number may be in a format compatible with that of Automated Clearing House (ACH) network. Payment provider server 170 may designated the payment amount into the newly generated virtual account. Thus, adequate funding may temporarily be set aside in the virtual account for the money order.

The service provider may partner with a bank and may designate a group of account numbers that may be used as virtual accounts to store temporary funds for money orders that are still pending. These virtual accounts may be reused repeatedly. For example, when a virtual account is holding a payment fund that has not been drawn by a pending money order, the virtual account may not be available to hold another payment fund. On the other hand, the virtual account may become available after the payment fund has been drawn by the money order when the payee cashes or deposits the money order.

In one embodiment, the virtual account may have an expiration time. For example, if a virtual account has an expiration time of three months, the virtual account may self-expire after three months even when the payment fund is not drawn by the payee. The payment fund may be returned to the payment account of the payer and the money order, which has not been cashed or deposited by the payee, may become void. Thus, if the payee fails to cash or deposit the money order for reasons, such as lost money order, the money order may automatically be void after the expiration time of the virtual account.

At step 208, the user may choose from one of a plurality of themes and styles of money order or checks. For example, themes, such as classic theme associated with traditional money order, cartoon character theme, popular cultural theme, musical theme, or the like, may be available for the user's choosing. The money order also may be printed with different colors and style. For example, the user may choose different background color or text fonts for printing the money order.

At step 210, the user may be presented with an option of printing the money order using user device 110. For example, user device 110 may be connected to a printing device by a wire or wirelessly. The user also may choose not to print the money order using user device 110 or may choose to print the money order later. If the user chooses to print the money order using user device 110 at step 210, payment provider server 170 may generate a money order image at step 212. The money order print image may include the information of the payee, amount of the payment, and the ACH routing number of the virtual account. Further, the money order print image may be generated based on the theme and style chosen by the user. Payment provider server 170 may then forward the money order image to user device 110. User device 110 may forward the money order image to a printing device connected to user device 110 to be printed.

If the user chooses not to print the money order using user device 110 at step 210, payment provider server 170 may generate a code for the money order at step 216. The code may be encrypted. In particular, information for the money order, such as the identity of the payee, the payment amount, and the routing number of the virtual account in which the payment amount is stored, may be encrypted in the code. The code also may include information indicating the theme and style of the money order. In one embodiment, the code may be an unique identification that is associated with the payment transaction. The code may be a bar code, an image, a QR code, or the like.

At step 218, payment provider server 170 may send the code to the user at user device 110. For example, if a printing device is not accessible to the user, the user may save the code in user device 110 and may bring the code to a participating merchant to print out the money order at the participating merchant's store front. In one embodiment, the user may send the money order to the payee or a person who is entrusted by the user to pick up the money order for the user. The payee or the entrusted person may bring the code to a participating merchant's store front to print out the money order.

By using the above process, an electronic payment may be associated with a virtual account with an ACH routing number. Thus, a physical payment instrument, such as a money order or a check, may be issued from the electronic payment. The payment fund may temporarily be stored in the virtual account to ensure that payment fund is available when the physical payment instrument is cashed or deposited. Accordingly, the user of the payment account may issue a physical payment instrument for payees that do not accept electronic payment.

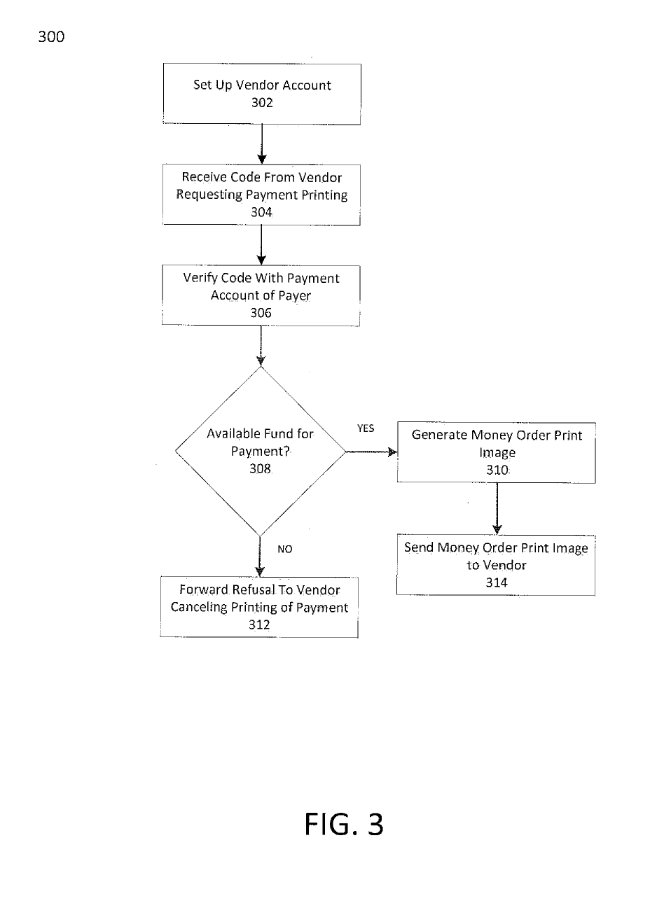

FIG. 3 is a flowchart showing a process 300 for printing out a physical payment instrument, e.g., a money order or check, at a participating merchant. At step 302, the merchant may become a participating merchant by setting up a vendor account with the payment service provider. Payment provider server 170 may store vendor account information of the participating merchants. Vendor account information may include the name, location, and store hours, and the type of products or services offered by the vendor.

When a user or a payee wishes to print a money order using the code, the user or payee may bring the code associated with the money order to a participating store. In one embodiment, the user or payee may access the payment service provider's website to find the closest participating merchants to the user or payee. For example, user's device 110 may include a GPS device and may detect the location of the user or payee. User's device 110 then may forward the location of the user or payee to payment provider server 170. Payment provider server 170 may determine a list of participating merchants located near the user and forward the list of nearby participating merchants to the user's device 110.

The list of nearby participating merchants may include information such as: the name, location, operating hours of each merchant. Further, the list also may include type of goods and services offered at each participating merchant. Advertisements for the goods or services of the participating merchants may also be provided to the user or payee. Thus, in addition to printing a money order, the user may choose a participating merchant that is most suitable for his or her need. For example, besides picking up the money order, a user or payee may wish to pick up groceries. Thus, the user or payee may choose a nearby participating merchant that offers grocery products. A participating merchant may wish to include advertisements in the list of nearby participating merchant by paying additional advertisement fees to the service provider. Thus, the participating merchant may attract additional customers to increase business.

The user or payee may choose a participating merchant and may visit the participating merchant's store. At the participating merchant's store, the user or payee may present the code for printing the money order to the participating merchant. The participating merchant may scan or enter the code at merchant device 140. Merchant device 140 may forward the code to the payment service provider. Payment provider server 170 may receive the code for printing the money order from merchant device 140 at step 304. Payment provider server 170 may verify the code with the payment account at step 306. For example, the code may be encrypted and payment provider server 170 may decrypt the code to obtain information regarding the payment transaction including the identification of the payee and the ACH routing number of the virtual account. Payment provider server 170 also may confirm that the virtual account associated with the ACH routing number is still active, e.g., and that adequate payment amount is available in the virtual account at step 308. For example, the virtual account may have an expiration time and may become inactive after the expiration time. If the virtual account becomes inactive, the payment fund stored in the virtual account may be returned to the payment account from which it originated when the virtual account becomes inactive.

If payment provider server 170 determines that the fund for the amount indicated in the money order is not available in the virtual account associated with the ACH routing number, payment provider server 170 may forward a refusal to merchant device 140 at step 312 to cancel the money order printing. In one embodiment, payment provider server 170 may provide reason for refusing the printing of money order. For example, payment provider server 170 may indicate that ACH routing number is not valid as the reason for refusing the money order printing.

In one embodiment, payment provider server 170 may commit funds to the virtual account after the money order is printed or activated. Payment provider server 170 may determine a source of funding for the payment based on the payment account user's designation or based on availability of funds in the user's various funding sources. For example, the user may associate various bank accounts, credit cards, debit cards, instant ACH, or Bill Me Later credit lines to the payment account for funding the account. Payment provider server 170 may monitor the funding availability of these various funding sources and determine an appropriate funding source for the payment. Thus, when the money order is printed or activated, an appropriate funding source may be used to fund the payment and the payment amount may be committed to the virtual account ready for payment.

If payment provider server 170 determines that the fund for the amount indicated in the money order is available in the virtual account associated with the ACH routing, payment provider server 170 may generate a money order print image including the payee information, the amount of payment, and the ACH routing number of the virtual account storing the payment at step 310. The money order print image may also be generated based on the theme and style chosen by the payer, as noted in step 208 above. Payment provider server 170 may send the money order print image to merchant device 140 at step 314. Merchant device 140 may then send the money order print image to printing device 165 to print out the money order.

In one embodiment, the user may choose a type of paper on which the money order is printed. The participating merchant may provide different types of paper for printing the money order. For example, the participating merchant may have plain paper, paper with security features, such as water marks or embedded features that provide additional security to prevent counterfeiting of money orders or checks. In one embodiment, the payment service provider may provide a specialized type of paper to the participating merchants for money order or check printing. For example, the payment service provider may provide blank money orders or checks containing trademarks of the payment service provider in security water marks. Thus, additional security may be added to the money order or checks printed at the participating merchants. Further, the trademarks included in the money order may provide assurance to a payee that the money order is a legitimate payment instrument.

In one embodiment, advertisements may also be printed along the money order. For example, advertisements or coupons for goods and services provided at the participating merchant may be printed on a reverse side of the money order. Thus, additional business may be generated from the money order printing process for the participating merchants.

After the money order is successfully printed, merchant device 140 may confirm with payment provider server 170 that a money order has been printed from the virtual account. Payment provider server 170 may flag the virtual account to indicate that a money order has already been printed for the payment. Thus, payment provider server 170 may prevent duplicate printing of the money order for the same payment.

In one embodiment, the money order may be forwarded to a payee. The payee may contact the payment service provider to confirm that adequate fund is available for the money order. For example, the payee may access a website of the payment service provider and may provide the payment service provider with the routing number listed on the money order. The payment service provider may then inform the payee whether the payment amount is available in the virtual account associated with the routing number. Thus, the payee may confirm the availability of the payment amount on the money order before cashing or depositing the money order.

In one embodiment, a virtual account may be used to issue multiple money orders or checks. For example, a payment account user may designate an amount of fund for a virtual account and may issue multiple checks from the virtual account up to the amount of fund designated to the virtual account. Each of the checks may have an unique check number but may have the same routing number associated with the virtual account. Thus, the virtual account may be used as a checking account for issuing multiple check payments.

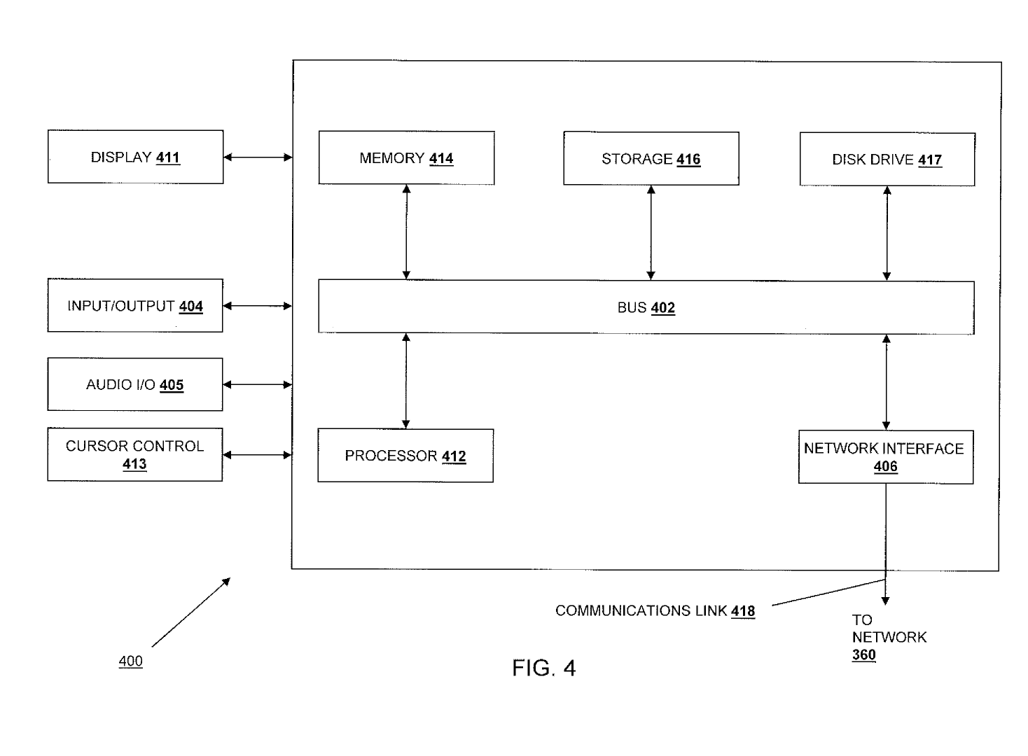

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise, Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for converting an electronic payment to a payment instrument, the system comprising:
a memory storing payment account information of a payer;
one or more processors in communication with the memory adapted to:
receive, electronically by a processor of a payment service provider, a request for a payment via a payment instrument using a payment account of the payer;
generate a virtual account associated with a routing number for the payment; and
designate an amount of the payment from the payment account to the virtual account;
generate a code for printing a payment instrument based on the amount of the payment and the virtual account;
receive an activation request from the payer for activating the code;
verify the activation request with the payment and the payment account of the payer; and
activate the code for printing a payment instrument when the activation request is verified.

2. The system of claim 1, wherein the routing number is an Automatic Clearing House routing number including a bank number and an account number.

3. The system of claim 1, wherein the code is encrypted with information including the routing number of the virtual account and an identification of a payee.

4. The system of claim 1, wherein the payment instrument is one of a money order and a check.

5. The system of claim 1, wherein the one or more processors is further adapted to:
receive the code from a merchant registered at the payment service provider;
verify the code received from the merchant;
generate a print image for the payment instrument based on the code; and
send the print image for the payment instrument to the merchant to print the payment instrument based on the print image.

6. The system of claim 5, wherein the step of verifying the code comprises confirming that a virtual account is associated with the routing number included in the code and that the amount of the payment is available in the virtual account;

7. The system of claim 5, wherein the print image for the payment instrument includes a name and an address of the payee and the routing number of the virtual account.

8. The system of claim 1, wherein the virtual account has an expiration time and wherein, when the virtual account is inactivated after the expiration time, the payment amount designated to the virtual account is returned to the payment account.

9. A method for converting an electronic payment to a payment instrument, the method comprising:
receiving, electronically by a processor of a payment service provider, a request for a payment via a payment instrument using a payment account registered at the payment service provider;
generating a virtual account associated with a routing number for the payment; and
designating an amount of the payment from the payment account to the virtual account;
generating a code for printing a payment instrument based on the amount of the payment and the virtual account;
receiving an activation request from the payer for activating the code;
verifying the activation request with the payment and the payment account of the payer; and
activating the code for printing a payment instrument when the activation request is verified.

10. The method of claim 9, wherein the routing number is an Automatic Clearing House routing number including a bank number and an account number.

11. The method of claim 9, wherein the code is encrypted with information including the routing number of the virtual account and an identification of a payee.

12. The method of claim 9, wherein the payment instrument is one of a money order and a check.

13. The method of claim 9, further comprising:
receiving the code from a merchant registered at the payment service provider;
verifying the code received from the merchant;
generating a print image for the payment instrument based on the code; and
sending the print image for the payment instrument to the merchant to print the payment instrument based on the print image.

14. The method of claim 13, wherein the verifying the code comprises confirming that a virtual account is associated with the routing number included in the code and that the amount of the payment is available in the virtual account;

15. The method of claim 13, wherein the print image for the payment instrument includes a name and an address of the payee and the routing number of the virtual account.

16. The method of claim 9, wherein the virtual account has an expiration time and wherein, when the virtual account is inactivated after the expiration time, the payment amount designated to the virtual account is returned to the payment account.

17. A non-transitory machine-readable medium comprising a plurality of machine-readable instructions which when executed by one or more processors of a server are adapted to cause the server to perform a method comprising:
receiving, electronically by a processor of a payment service provider, a request for a payment via a payment instrument using a payment account registered at the payment service provider;
generating a virtual account associated with a routing number for the payment; and
designating an amount of the payment from the payment account to the virtual account;
generating a code for printing a payment instrument based on the amount of the payment and the virtual account;
receiving an activation request from the payer for activating the code;
verifying the activation request with the payment and the payment account of the payer; and
activating the code for printing a payment instrument when the activation request is verified.

18. The non-transitory machine-readable medium of claim 17, wherein the routing number is an Automatic Clearing House routing number including a bank number and an account number.

19. The non-transitory machine-readable medium of claim 17, wherein the code is encrypted with information including the routing number of the virtual account and an identification of a payee.

20. The non-transitory machine-readable medium of claim 17, wherein the payment instrument is one of a money order and a check.
